(19) United States
(12) Patent Application Publication
(10) Pub. No.: US 2005/0221012 A1
(43) Pub. Date: Oct. 6, 2005

(54) Method for manufacturing a lightfast synthetic leather and products manufactured according to the method

(76) Inventors: Horst Muehlfeld, Grasellenbach (DE); Frank Jestel, Kunheim (FR); Robert Groten, Sundhoffen (FR); Ulrich Jahn, Labaroche (FR); Thomas Schauber, Hemsbach (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/068,249

(22) Filed: Feb. 28, 2005

(30) Foreign Application Priority Data
Mar. 1, 2004 (DE) DE 10 2004 010 45

(51) Int. Cl. B05D 3/02

(52) U.S. Cl. 427/372.2

(57) ABSTRACT

A method for manufacturing a synthethic leather includes the steps of obtaining a polyurethane prepolymer from isocyantates and linear hydroxyl-terminated polyols having molecular weights of 500 to 5,000 g/mol, wherien the isocyanates include at least one of aliphatic, cyclophatic, and non-aromatic heterocyclic di- and or tri-isocyanates. A first aqueaous dispersion of the polyurethane prepolymer is provided and mixed with a second aqueous dispersion or solution of a catalyst and at least one cross-linking constituent so as to create a mixture. The method further includes impregnating a textile fabric with the mixture and drying and reacting the prepolymers to completion at a temperature from 80 to 180° C. In addition, a synthetic letter manufactured according to the method.

Priority is claimed to German Patent Application No. DE 10 2004 010 456.5, filed Mar. 1, 2004, which is incorporated by reference herein.

### BACKGROUND

The present invention is directed to a method for manufacturing a lightfast synthetic leather, as well as to products manufactured according to the method.

In already known synthetic leathers, the softness is achieved, inter alia, by resist-treating the surface of the fibers of the nonwoven fabric with cold water-soluble polyvinyl alcohol, before it is impregnated with polyurethane (PU) solutions (PU dissolved in organic solvents, mostly dimethylformamide). Following the impregnation and coagulation of the polyurethane in water, the polyvinyl alcohol is washed out, together with the organic solvent, in the subsequent wash cycles. Other water-soluble resisting agents or temporary fillers, such as poly-ε-caprolactone, carboxymethylcellulose or starch, are also used.

For applications using aqueous binding agents, it is necessary to use hot water-soluble polyvinyl alcohol. It has also already been described to incorporate hot water-soluble PVA fibers directly in the manufacturing of the nonwovens. The hot water-soluble fibers can be dissolved out at the same time that an exhaust dyeing process is carried out, in particular in autoclaves.

The synthetic leathers that are obtained undergo a generally known aftertreatment in which they are sanded and brushed.

These or similar processes are described in the following documents:

From the document EP-A 0 090 397, which is incorporated by reference herein, synthetic products having leather-like properties are known, which are fabricated from nonwoven fabrics having a polyurethane impregnation and/or coating. The nonwoven fabrics made of ultrafine, entangled filaments have a multilayered structure and are produced from islands-in-a-sea type starting fibers. The nonwoven fabrics are impregnated by coagulating an aromatic polyurethane DMF solution in the water bath.

The document EP 1 353 006, which is incorporated by reference herein, describes nonwoven fabrics which are impregnated with polyurethane and are fabricated from conjugate staple fibers of the islands-in-a-sea type. The impregnation is carried out using aqueous polyurethane emulsions and polyurethanes in organic solvents in accordance with the following processes:
coagulation in acidic or saline solutions;
microwave or radio wave drying;
treatment using saturated steam and thickening agents.

From German Patent Application DE-A 199 47 869, which is incorporated by reference herein, synthetic leathers are known, in the case of which a nonwoven fabric produced from split filaments is impregnated with polyurethane solutions or dispersions. The products obtained still have disadvantages with respect to light fastness and haptic properties. In addition, from the documents WO 01/27179 A1, U.S. Pat. No. 6,017,997 and WO 02/08327 A1, each of which is incorporated by reference herein, methods are known for manufacturing aqueous polyurethane prepolymers, as well as uses thereof for impregnating textile materials. In this context, aqueous polyurethane prepolymer dispersions are made to react by a cross-linking constituent, and textiles, in particular nonwoven fabrics, are subsequently impregnated. No reference to the light fastness or the haptic properties of the products manufactured according to such methods can be inferred from these documents.

### SUMMARY OF THE INVENTION

An object of the present invention is to provide a method for manufacturing a synthetic leather and products manufactured according to the method, which exhibit a higher light fastness and improved haptic properties, i.e., a softer feel, and which are able to be manufactured in a simple, cost-effective, and environmentally friendly process.

The method is carried out in accordance with the present invention in that textile fabrics are impregnated with the mixture of:
a) an aqueous dispersion of a polyurethane prepolymer obtained from aliphatic, cycloaliphatic and/or non-aromatic heterocyclic di- and/or tri-isocyanates and linear, hydroxyl-terminated polyols having a molecular weight of 500 to 5,000 g/mol; and
b) an aqueous dispersion or solution of a catalyst and at least one cross-linking constituent, and are produced by drying the prepolymers as well as reacting the same to completion at temperatures of between 80 to 180° C.

The nonwoven fabrics are impregnated in a simple process step in which they are impregnated with the reactive polyurethane-prepolymer dispersion that is mixed with the chain extender or cross-linking agent, in an apparatus not specially manufactured for that purpose, rather in a conventional padding machine, followed by the drying process.

Surprisingly, it was found that by implementing the simple and environmentally-friendly step of impregnating the nonwoven fabrics according to the present invention with reactive PU prepolymers, which only react to completion during the drying process to form long-chain and cross-linked polyurethanes, soft, leather-like products are obtained. The products obtained in accordance with the method of the present invention exhibit an improved light fastness and a softer feel. A nonwoven fabric is advantageously used as the textile fabric.

Today, synthetic leathers are composed virtually exclusively of microfiber-containing textiles. Since the microfibers, themselves, are only able to be processed at very slow production speeds into textiles, for the most part, multicomponent fibers are used. There are various types of multicomponent fibers, such as matrix- fibril bicomponent (islands-in-a-sea type) fibers, for example, or those fibers whose cross sections exhibit an orange structure or a cake or hollow cake structure. Such conjugate or multicomponent fibers are composed of at least two, preferably, however, up to approximately 18 segments. The segments of the mostly two polymers alternate with each other within the multicomponent fiber, so that fiber boundary surfaces, such as polyethylene terephthalate/polyamide 6, form between the segments. Various methods exist for separating such multicomponent fibers to form isolated microfibers. Thus, for example, one of the two fiber components is treated with organic solvents or, as in the case of polyethylene terephthalate/polyamide 6, the polyester is subjected to alkaline saponification, so that the other insoluble fiber component remains as a microfiber. These methods are costly, not very environmentally friendly, and associated with a substantial loss of material.

### BRIEF DESCRIPTION OF THE DRAWING

The present invention is described in further detail below with reference to the drawing, in which:

FIG. 1 is a flow chart schematically illustrating a method for manufacturing a synthetic leather according to the present invention

### DETAILED DESCRIPTION

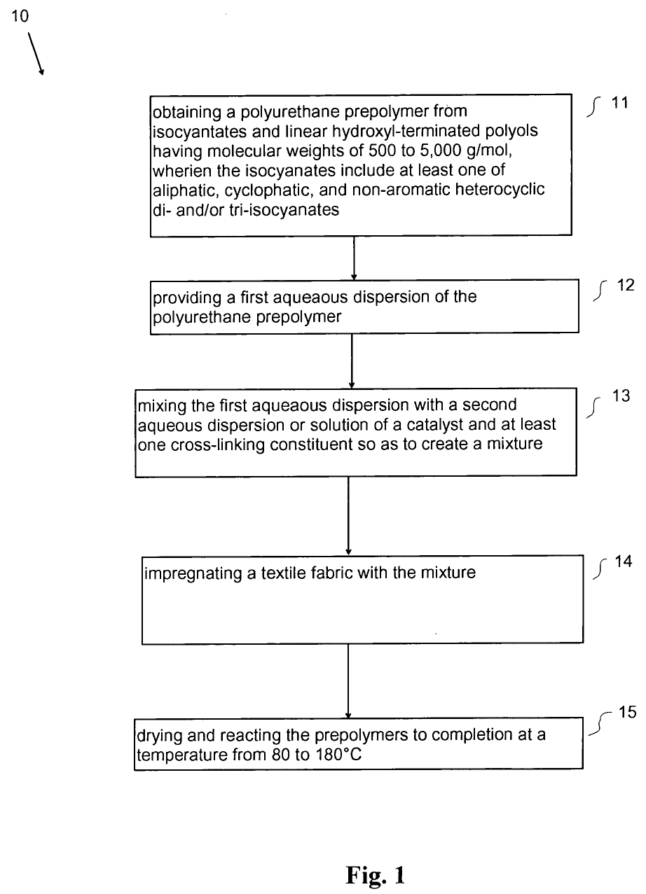

As shown in FIG. 1, method 10 for manufacturing a synthetic leather includes, in a first step, obtaining a polyurethane prepolymer from isocyantates and linear hydroxyl-terminated polyols having molecular weights of 500 to 5,000 g/mol. See block 11. The isocyanates include at least one of aliphatic, cyclophatic, and non-aromatic heterocyclic di- and/or tri-isocyanates. In a second step, a first aqueaous dispersion of the polyurethane prepolymer is provided. See block 12. Next, the first aqueaous dispersion is mixed with a second aqueous dispersion or solution of a catalyst and at least one cross-linking constituent so as to create a mixture. See block 13. A textile fabric is impregnated with the mixture. See block 14. In a further step, the prepolymers are dired and reacted to completion at a temperature from 80 to 180° C. See block 15.

It is especially preferred for a nonwoven fabric made of microfilaments having a titer of <0.5 dtex, preferably of between 0.01 and 0.2 dtex to be used. Such nonwoven fabrics are fabricated from multicomponent filaments, which, viewed in cross section, are disposed in an alternating arrangement, the individual components forming boundary surfaces along which a splitting into individual microfilaments is carried out, for example by a hydrofluid treatment. More environmentally friendly is the process preferred today of splitting the fibers using high-pressure water jets. The bicomponent fibers suited for this purpose are either composed of thermoplastics, whose chemical properties differ substantially and which exhibit only low adhesion forces at the boundary surfaces, or, in the case of chemically similar fiber polymers, such as polyolefins, have release additives added thereto.

The method according to the present invention is further refined in that water is used as a cross-linking constituent, dispersion b) only being composed of water and a catalyst. Using exclusively water as a cross-linking constituent leads already to products which exhibit a higher light fastness and a softer feel as compared to those products which are impregnated with polyurethane solutions or dispersions which are reacted to completion.

Alternatively thereto, an aliphatic diol, triol, tetrol and/or an amino alcohol having molecular weights of between 60 and 400 g/mol are used as cross-linking constituents in dispersion b). The ratio of the free isocyanate groups of the polyurethane prepolymer in dispersion a) to the free hydroxyl groups and amino groups of the di-, tri- and tetrols, as well as amino alcohols in dispersion b) is advantageously selected to be within the range from 0.9:1.0 to 1.8:1.0.

A beneficial, further alternative is for hexamethylene dicarbamate to be used as a cross-linking constituent in dispersion b). When this cross-linking constituent is used, following the reaction to completion of the prepolymers and a temperature treatment in the range from 90° to 160° C., foamed products are obtained.

Another embodiment of the method according to the present invention provides that the prepolymerization for preparing the polyurethane prepolymer take place at temperatures from 120 to 180° C., that polyurethane prepolymer be mixed at a temperature of <80° C. with 0.8 to 10 parts by weight of an emulsifier based on 100 parts by weight of polyurethane prepolymer and be dispersed in deionized water. To prepare the prepolymers according to the present invention, aliphatic, cycloaliphatic and heterocyclic diisocyanates, for example, come under consideration. Specifically mentioned are, for example: hexamethylene diisocyanate, isophorone diisocyanate, 1,4-cyclohexane diisocyanate, 1-methyl-2,4-cyclohexane diisocyanate, 1-methyl-2,6-cyclohexane diisocyanate, 4,4-dicyclohexylmethane diisocyanate, 2,4-dicyclohexylmethane diisocyanate, 2,2-dicyclohexylmethane diisocyanate, as well as isomer mixtures thereof.

The mentioned diisocyanates may be used individually or in the form of mixtures thereof. They may also be used together with aliphatic triisocyanates and polyisocyanates. Suitable are, for example, the trimers and condensates of hexamethylene diisocyanate having a biuret structure. Quantities of triisocyanate and polyisocyanate may be added, however, only to the point where a prepolymer obtained for the dispersion in water is still fluid or meltable.

Linear, hydroxyl-terminated polyols having an average molecular weight of 500 to 5,000 g/mol are preferably used as polyols for preparing the prepolymers.

Polyesterdiols, polyetherdiols, polycarbonatediols and polysiloxanediols or mixtures thereof are preferably used.

Suitable polyether polyols are the reaction products which are obtained from the alkylene oxides, ethylene oxide, propylene oxide and butylene oxide. In addition, suitable polyether polyols are the hydroxyl group-containing polymerization products of the tetrahydrofuran.

As polyesterdiols, preferably ethanediol polyadipates, butanediol polyadipates, ethanediol-butanediol polyadipates, hexanediol polyadipates, hexanediol-neopentyl glycol polyadipates, hexanediol-butanediol polyadipates and polycaprolactones are used.

As chain extenders and cross-linking agents of the prepolymers, water, aliphatic diols, triols and tetrols, as well as aliphatic and cycloaliphatic amino alcohols and diamines having blocked NH groups having a molecular weight of 60 to 400 g/mol are used.

Suitable are, for example, the hydroxyl group-containing (OH-functional) chain extenders and cross-linking agents, water, ethanediol, butanediol, hexanediol, diethylene glycol, dipropylene glycol, cyclohexanediol, bis(hydroxymethyl)cyclohexane, trimethylolpropane, pentaerythrite, ditrimethylol-propane, dipentaerythrite.

As NH-functional chain extenders, preferably mono-, di- and triethanolamine, aminoethylethanolamine, aminopropanol, neopentanolamine and hexamethylene diamine carbamate are used.

Mixtures of the above-mentioned chain extenders and cross-linking agents may also be used.

For the dispersion in water, the prepolymer is cooled to below 80° C., preferably to 20 to 50° C., and mixed with the emulsifier, the emulsifier quantity based on 100 parts by weight of prepolymer amounting to 0.8 to 10.0 parts by weight, preferably to 2.0 to 5.0 parts by weight.

The prepolymers may be dispersed in water discontinuously or also continuously.

In the discontinuous or batch process, water is slowly added to the prepolymer-emulsifier mixture at a high agitation speed using a dispersion disk agitator. 100 to 1,000 parts by weight of water, preferably 150 to 400 parts by weight of water are added to 100 parts by weight of prepolymer. The prepolymer is mixed with the emulsifier in a continuous process in an aggregate using a mixing head equipped with a high-speed spiked agitator. This mixture is subsequently processed in a dispersion mill, while the appropriate amount of water is simultaneously added to a reactive PU dispersion that is stable in storage for 24 hours.

In another preparation step, the chain extender and/or cross-linking agent, which had been dissolved or dispersed in water, is added to the aqueous PU dispersion in such quantities that the equivalent ratio of the free NCO groups in the prepolymer to the sum of the OH groups and NH₂ groups of the chain extenders and cross-linking agents is 0.9:1.0 to 1.8:1.0, preferably 0.95:1.0 to 1.3:1.0. The constituents are reacted while being agitated at a temperature above 100° C., preferably of between 120° and 140° C.

To effect the chain lengthening of the prepolymer using water to produce a polyurethane polyurea, only one catalyst, preferably a tertiary amine, is added to the prepolymer dispersion.

The additives and auxiliary agents may be added to the prepolymer by mixing them in before the dispersion and/or added to the PU dispersion after first dissolving or dispersing them in water.

The nonwoven fabric is impregnated at room temperature, for the impregnation of the nonwoven fabric such quantities of PU dispersion being selected that, following the drying and postreaction, the synthetic leathers contain a PU amount of 5 to 75, preferably of 15 to 40 percent by weight. Prior to the drying and polymerization, a treatment may also take place in a steamer.

The impregnated nonwoven fabrics are tempered for the drying and postreaction of the PU prepolymers in a temperature range from 800 to 180° C., preferably at 100° to 140° C. For the drying process, besides conventional convection and infrared dryers, microwave dryers are also possible.

The impregnation process may be carried out discontinuously or continuously. In the discontinuous process, the nonwoven fabrics according to the present invention are impregnated with the PU prepolymer dispersion according to the present invention; the excess dispersion is pressed out; and the impregnated nonwoven fabric is after-treated under the conditions described above for the drying and postreaction.

In the continuous process, the nonwoven fabric is impregnated in accordance with the related-art method, in a padding machine, and the tempering process for drying the nonwoven fabric and for the postreaction of the PU prepolymers takes place in a heating channel.

The thus treated nonwoven fabrics are subsequently dyed in accordance with the known dyeing methods in the known dyeing aggregates, preferably discontinuously in a jet dyeing apparatus.

The synthetic leathers in accordance with the present invention acquire a suede leather-like feel by sanding and/or roughening, as well as brushing the surface.

The synthetic leathers in accordance with the present invention may be prepared for special applications by lacquering and coating surface treatments, for example, using polymer systems and process engineering techniques known from the related art.

Due to their leather-like haptic properties, high light fastness, good strength properties and good abrasion resistance, the synthetic leathers according to the present invention are suited, in particular, for synthetic leather applications in the automotive interior sector, upholstery sector, and for high-quality articles of clothing.

The type of emulsifier—anionic, cationic or nonionic—is selected as a function of the nature of the polyurethane prepolymer. Anionic, cationic and nonionic emulsifiers are suited for the dispersion of the aliphatic PU prepolymers in water. Preferably, emulsifiers having a high proportion of hydrophilic groups are used which are suited for preparing oil-in-water emulsions. Suitable are, for example, oleic acid ethoxylate, fatty alcohol ethoxylate, castor oil ethoxylate, alkylphenol ethoxylate.

The equivalent ratio of the isocyanate groups to the hydroxyl groups when preparing the polyurethane prepolymer is advantageously selected in the range from 1.2:1.0 to 4.5:1.0. The PU prepolymers are obtainable from the above-mentioned polyols and diisocyanates, if indicated, in the presence of catalysts. In this manner, polyurethane prepolymers are obtained, which have still free, i.e., reactive isocyanate terminal groups for the subsequent cross-linking reaction and formation of a polyurethane.

Especially preferred as polyol constituents for preparing the polyurethane prepolymer are linear, hydroxyl-terminated polyols selected from the group of polyesterdiols, polyetherdiols, polycarbonatediols and polysiloxanediols, as well as mixtures thereof.

In a further refinement of the method, diethyl malonate, dimethylpyrazole, methyl ethyl ketoxime, or caprolactam may be used to block the isocyanate groups in the polyurethane prepolymer.

Flame retardants, dyestuffs, pigments, fillers, expanding agents and/or softening agents are advantageously added to the polyurethane prepolymer of dispersion a) and/or dispersion b). Other additives, which may be contained in the PU dispersion, are expanding agents, which produce a foamed structure in response to an elevated temperature and the resultant gas separation in the impregnated nonwoven fabric. Also suited are microparticles, which encapsulate a propellant gas and expand by the action of temperature into microspheres having a polymer shell.

Also suited to be incorporated are commercial softening agents, such as phosphates, adipates, sebacates, and alkylsulphonic acid esters.

It is especially preferred for the method to be implemented by using catalysts, such as tertiary amines and/or organic metal compounds, for the prepolymer reaction, as well as for the cross-linking reaction. Finally, the present invention is directed to synthetic leathers which are obtained in accordance with the method of the present invention. The synthetic leathers according to the present invention advantageously undergo an aftertreatment including splitting, buffing, sanforizing, and/or dyeing.

The synthetic leathers in accordance with the present invention acquire a suede leather-like feel by sanding and/or roughening, as well as brushing the surface. The synthetic leathers in accordance with the present invention may be prepared for special applications by lacquering and coating surface treatments, for example, using polymer systems and process engineering techniques known from the related art.

Due to their leather-like haptic properties, high light fastness, good strength properties and good abrasion resistance, the synthetic leathers according to the present invention are suited, in particular, for synthetic leather applications in the automotive interior sector, upholstery sector, and for high-quality articles of clothing.

The present invention is explained in greater detail with reference to the following examples.

### EXAMPLE 1

A filament-based nonwoven fabric having a weight per unit area of 175 g/m² is manufactured from a polyester-polyamide bicomponent continuous filament and subjected to a water jet needling process. Following the water jet needling process, which leads to a simultaneous splitting of the starting filaments, the bicomponent continuous filaments have a titer of <0.2 dtex. For the impregnation of the strengthened nonwoven fabric, a reactive PU dispersion is prepared in the following composition and in accordance with the following process:
400.00 parts by weight of polypropylene glycol having a molecular weight of 2,000 g/mol and OH number 58;
600.00 parts by weight of polytetrahydrofuran, molecular weight of 2,000 g/mol and OH number 56;
220.00 parts by weight of isophorone diisocyanate
are reacted in a reactor while undergoing intense agitation for three hours at 120° C. to form a prepolymer having an isocyanate residual content of 3.02%.

The prepolymer is cooled to room temperature and mixed with an emulsifier having a fatty alcohol ethoxylate-based anionic and nonionic portion, in an amount of 3.5 parts by weight based on 100 parts by weight of prepolymer.

For the dispersion of the prepolymer in water, water is slowly added to the prepolymer-emulsifier mixture at a high agitation speed using a dispersion disk agitator in amounts of 400 parts by weight based on 100 parts by weight of prepolymer.

A PU dispersion is obtained that is stable in storage for two days.

In another process step, 500 parts by weight of the above-described PU prepolymer dispersion; 54.28 parts by weight of the cross-linking solution composed of 4.28 parts by weight of ditrimethylol-propane having a molecular weight of 250 g/mol and OH number 900; and 50.0 parts by weight of water, which was previously prepared by dissolving ditrimethylol-propane in moderately heated water, are added with agitation.

The above-described nonwoven fabric is impregnated with the reactive PU dispersion in a padding machine, in which the non-woven fabric is impregnated with the PU dispersion, and the excess dispersion is subsequently pressed out between two rollers under a pressing pressure of 5 bar.

The impregnated nonwoven fabric is tempered in a heating oven for four minutes at 120° C. for drying the nonwoven fabric and post-cross-linking of the prepolymer. A nonwoven fabric having a soft, highly cross-linked PU polymer impregnation is obtained, the PU impregnation amounting to 28% of the initial weight of the nonwoven fabric.

The nonwoven fabric impregnated with the highly cross-linked PU is sanded on the surface and may be provided with a special silicon, for example, for improving the feel. A soft synthetic leather having a nubuck-type surface is obtained.

### EXAMPLE 2

The catalyst triethylene diamine is added in an amount of 0.05 parts by weight based on 100 parts by weight of prepolymer, as an aqueous solution, to the reactive prepolymer dispersion described in Example 1, without any cross-linking constituents.

The nonwoven fabric described in Example 1 is impregnated in a padding machine under the conditions as described with reference to Example 1.

The impregnated and moist nonwoven fabric is treated between two press plates in a laterally sealed press frame at a low pressure at 110° C. for five minutes. The still moist nonwoven fabric is subsequently dried at 80° C.

A synthetic leather having a soft, foamed, and microcellular PU impregnation is obtained, the PU impregnation amounting to 22% of the initial weight of the nonwoven fabric. A surface treatment may be carried out as in Example 1.

### EXAMPLE 3

The nonwoven fabric described in Example 1 is impregnated with a reactive PU dispersion in the following composition and in accordance with the following process:
650.00 parts by weight of polycarbonatediol having a molecular weight of 2,000 g/mol and OH number 54;
350.00 parts by weight of polypropylene glycol, molecular weight of 2,000 g/mol and OH number 58;
280.00 parts by weight of dicyclohexylmethane diisocyanate having a molecular weight of 262 g/mol
are reacted in a reactor while undergoing intense agitation for three hours at 120° C. to form a prepolymer having an isocyanate residual content of 3.58%.

The prepolymer is mixed, analogously to Example 1, at room temperature, with a fatty alcohol ethoxylate-based emulsifier and dispersed in water at a high agitation speed using a dispersion disk agitator to form a PU dispersion that is stable in storage for two days.

Trimethylol propane, which was previously dissolved in water, is added to the dispersion in amounts of 3.65 parts by weight based on 100 parts by weight of the prepolymer.

The impregnation of the nonwoven fabric, and the drying and post-cross-linking of the prepolymer are carried out analogously to the conditions as described in the example.

A synthetic leather having a soft, highly cross-linked PU impregnation is obtained, the PU impregnation amounting to 29% of the initial weight of the nonwoven fabric. The synthetic leather differs in the haptic properties, in particular from the synthetic leather from Example 1, subsequently to the sanding of the surface, by an especially dry feel and good abrasion resistance.

### EXAMPLE 4

The nonwoven fabric described in Example 1 is impregnated with a reactive PU dispersion in the following composition and in accordance with the following process: 600.00 parts by weight of polycarbonatediol having a molecular weight of 2,000 g/mol and OH number 54;
400.00 parts by weight of polypropylene glycol, molecular weight of 2,000 g/mol and OH number 58;
180.00 parts by weight of isophorone diisocyanate having a molecular weight of 222 g/mol;
20.00 parts by weight of hexamethylene diisocyanate-based trimer having a molecular weight of 504 g/mol
are reacted in a reactor while undergoing intense agitation for three hours at 120° C. to form a prepolymer having an isocyanate residual content of 2.41%, the polyols being reacted in a prereaction with isophorone diisocyanate for 2.5 hours at 120° C., and the triisocyanate is subsequently added, and the mixture is agitated for another 0.5 hours at 120° C.

The prepolymer is mixed, analogously to Example 1, at room temperature, with a castor oil ethoxylate-based nonionic emulsifier and dispersed in water at a high agitation speed using a dispersion disk agitator to form a PU dispersion that is stable in storage for two days.

Hexamethylene diamine carbamate, which was previously dispersed in water at high agitation speed with the nonionic, castor oil ethoxylate-based nonionic emulsifier, is added to the dispersion in amounts of 4.39 parts by weight based on 100 parts by weight of prepolymer.

The impregnation of the nonwoven fabric, and the drying and post-cross-linking of the prepolymer are carried out analogously to the conditions as described in the example.

Due to the reaction of the prepolymer with the diamine carbamate, which leads, under heat, by splitting of the diamine carbamate into hexamethylene diamine and CO₂, to a chain lengthening and an expansion process, a synthetic leather having a soft, foamed, and microcellular PU impregnation is obtained, the PU impregnation amounting to 24% of the initial weight of the nonwoven fabric. As described in Example 1, the surface of the synthetic leather may undergo an aftertreatment to improve feel and achieve a nubuck-type structure.

### COMPARATIVE EXAMPLE

The commercially available, long-chain PU dispersions, which do not contain any free isocyanate groups for an OH and amine cross-linking, such as the Witcobond systems of the firm Baxender Chemicals, Astacin finish systems of BASF, and the Impranil systems of the firm Bayer, are used for impregnating the nonwoven fabric of Example 1 and in accordance with the process as described in Example 1.

In the case of all of the examined PU dispersions for impregnating the nonwoven fabric, hard and stiff products were obtained, which, after sanding the surface, did not exhibit a leather-like character. Also, a clearly inferior wet fastness of the impregnated nonwoven fabrics was ascertained as compared to the synthetic leathers according to the present invention.

Tests Performed on the Synthetic Leathers Obtained in the Examples:

Tensile test din en 29073-03: test of the maximum tensile strength and maximum tensile stress at 50 mm specimen width

Abrasion resistance in accordance with the Martindale method, DIN 53863, 50,000 cycles at a pressing pressure of 9 Kpa

Hot light fastness, DIN 75202-2B, at 110° C. and five cycles, assessment of the light fastness standard in accordance with the gray scale

| | | | | Hot light |
|---|---|---|---|---|
| | | | Abrasion resistance in | fastness |
| | Maximum | Maximum tensile | accordance with | 110° C./5 cycles |
| Synthetic | tensile strength | stress | Martindale, | light fastness |
| leather | (N) | (%) | 50,000 cycles/9 KPa | standard |
| Example 1 | lengthwise 544 | lengthwise 32 | no formation of holes | 5 |
| | transversely 531 | transversely 35 | | |
| Example 2 | lengthwise 482 | lengthwise 31 | no formation of holes | 5 |
| | transversely 473 | transversely 33 | | |
| Example 3 | lengthwise 548 | lengthwise 36 | no formation of holes | 5 |
| | transversely 542 | transversely 35 | | |
| Example 4 | lengthwise 498 | lengthwise 33 | no formation of holes | 4-5 |
| | transversely 482 | transversely 32 | | |
| Example 5 | | | | |
| aliphatic | lengthwise | lengthwise 30-35 | formation of holes | 4 to 4-5 |
| dispersions | 480-535 | transversely 30-34 | | |
| | transversely | | | |
| | 475-540 | | | |
| aromatic | lengthwise | lengthwise 30-36 | no formation of holes | 2-3 to 3-4 |
| dispersions | 495-545 | transversely 30-36 | | |
| | transversely | | | |
| | 480-540 | | | |

1. A method for manufacturing a synthethic leather, the method comprising:
obtaining a polyurethane prepolymer from isocyantates and linear hydroxyl-terminated polyols having molecular weights of 500 to 5,000 g/mol, wherien the isocyanates include at least one of aliphatic, cyclophatic, and non-aromatic heterocyclic di- and/or tri-isocyanates;
providing a first aqueaous dispersion of the polyurethane prepolymer;
mixing the first aqueaous dispersion with a second aqueous dispersion or solution of a catalyst and at least one cross-linking constituent so as to create a mixture;
impregnating a textile fabric with the mixture;
drying and reacting the prepolymers to completion at a temperature from 80 to 180° C.

2. The method as recited in claim 1, wherein the textile fabric includes a nonwoven fabric.

3. The method as recited in claim 2, wherein the nonwoven fabric includes microfilaments having a titer of <0.5 dtex.

4. The method as recited in claim 3, wherein the titer is between 0.01 and 0.2 dtex, is used.

5. The method as recited in claim 1, wherein the cross-linking constituent is water and wherein the second aqueous dispersion or solution includes only water and a catalyst.

6. The method as recited in claim 1, the cross-linking constituent includes an aliphatic diol, triol, and/or tetrol having a molecular weight between 60 and 400 g/mol.

7. The method as recited in claim 6, wherein a ratio of free isocyanate groups of the polyurethane prepolymer in the first aqueous solution to free hydroxyl groups of the di-, tri- and/or tetrols in the second aqeous dispersion or solution is between 0.9:1.0 and 1.8:1.0.

8. The method as recited in claim 1, wherein the cross-linking constituent includes at least one of an aliphatic amino alcohol and a hexamethylene diamine carbamate.

9. The method as recited in claim 1, wherein the obtaining of the polyurethane prepolymer includes a prepolymerization performed at a temperature from 80 to 140° C.; the providing of the first aqueous solution is perfomred at a temperature of less than 80° C. and includes dispersing 0.8 to 10.0 parts by weight of emulsifier based on 100 parts by weight of polyurethane prepolymer in deionized water.

10. The method as recited in claim 9, wherein a ratio of isocyanate groups to hydroxyl groups is in a range from 1.2:1.0 to 4.5:1.0.

11. The method as recited in claim 9, the linear hydroxyl-terminated polyols are selected from the group consisting of polyesterdiols, polyetherdiols, polycarbonatediols, polysiloxanediols, and mixtures thereof.

12. The method as recited in claim 9, further comprising blocking the isocyanate groups in the polyurethane prepolymer using at least one of methyl ethyl ketoxime and caprolactam.

13. The method as recited in claim 1 further comprising adding at least one of flame retardants, dyestuffs, pigments, fillers, expanding agents and softening agents to the polyurethane prepolymer.

14. The method as recited in claim 1, wherein the catalyst includes at least one of tertiary amines and organic metal compounds.

15. The method as recited in claim 1, further comprising a further catalyst including at least one of tertiary amines and organic metal compounds, and wherein the further catalyst is used for a prepolymer reaction and a cross-linking reaction.

16. The method as recited in claim 1, further comprising performing an aftertreatment after the impregnating, wherein the afterr treatment includes at least one of sanding, buffing, sanforizing, and dyeing.
